(19) United States
(12) Patent Application Publication
(10) Pub. No.: US 2016/0275498 A1
(43) Pub. Date: Sep. 22, 2016

(54) DATA BREACH DETECTION

(71) Applicant: INTERNATIONAL BUSINESS MACHINES CORPORATION, Armonk, NY (US)

(72) Inventors: Yan Moyaux, Southbury, CT (US); John G. Musial, Newburgh, NY (US); Jan S. Pluim, Cary, NC (US); Todd R. Whitman, Bethany, CT (US)

(21) Appl. No.: 14/659,692

(22) Filed: Mar. 17, 2015

(51) Int. Cl. G06Q 20/38; G06Q 20/40

(52) U.S. Cl. CPC G06Q 20/382; G06Q 20/4016

(57) ABSTRACT

According to one aspect, data breach detection includes creating, by a computer processor of a financial institution, a single use tracking account; mapping the single use tracking account to a single target entity in an account record stored by the financial institution; and processing an initial transaction resulting from utilization of the mapped single use tracking account with the target entity. A further aspect includes generating an alert upon determining any subsequent use of the single use tracking account.

### BACKGROUND

The invention relates to data security, and more specifically, to data breach detection using trackable accounts.

Data breaches in large-scale storage facilities are occurring at an alarming rate. Thus, for millions of individuals, a single occurrence of a data breach can cause devastating results in terms of privacy loss.

Data breaches can happen under varying circumstances and oftentimes go undetected by the account owner, and/or unreported by the retailer, for days, weeks, or even months. The longer the delay in detection, the greater the incidence of damage caused by the breach. Working to prevent data breaches is an ongoing challenge. What is becoming of equal importance is the ability to provide rapid detection and effective responses to existing breaches in order to mitigate damages.

### SUMMARY

According to an embodiment, a method for data breach detection is provided. The method includes creating, by a computer processor of a financial institution, a single use tracking account, mapping the single use tracking account to a single target entity in an account record stored by the financial institution, and processing an initial transaction resulting from utilization of the mapped single use tracking account with the target entity. The method also includes generating an alert upon determining any subsequent use of the single use tracking account.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings, which:

FIG. 1 depicts a cloud computing node in accordance with an embodiment of the invention;

FIG. 2 depicts a cloud computing environment according to an embodiment of the invention;

FIG. 3 depicts abstraction model layers according to an embodiment;

FIG. 4 depicts a system upon which data breach detection may be implemented in accordance with an embodiment of the invention;

FIG. 5 depicts a flow diagram of a high-level process for implementing data breach detection according to an embodiment of the invention; and

FIG. 6 depicts a flow diagram of a detailed process for implementing data breach detection according to an embodiment.

### DETAILED DESCRIPTION

Exemplary embodiments provide data breach detection using single use tracking accounts. The data breach detection processes utilize injected trackable account data as a means of rapid detection that a data breach has occurred. The account data includes records that are created and managed by an issuing financial institution and which is injected into a target entity's network at various points (e.g., online, point-of-sale (POS), phone orders, etc.) for various target entities in order to detect the occurrence of data theft. In an embodiment, the target entity may be a merchant. Each account reflects an identity (e.g., individual or enterprise) with valid associated credit/debit account information that is designated for injection into a specific point in the payment process for a specific target entity. The account is not eligible for use at more than one target entity or for any transaction beyond its initial use. The injection information is used to seed target entity payment systems to allow forensic analysis and to rapidly detect data theft. In an embodiment, any subsequent use or attempted use of the single use tracking account may represent a breach and thus results in the generation of an alert. These, and other, features of the data breach detection processes will now be described.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services)that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

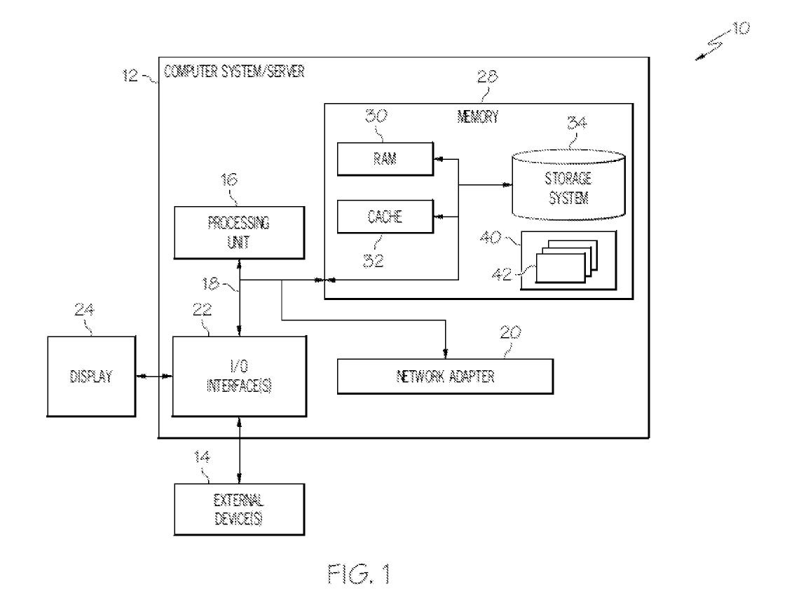

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

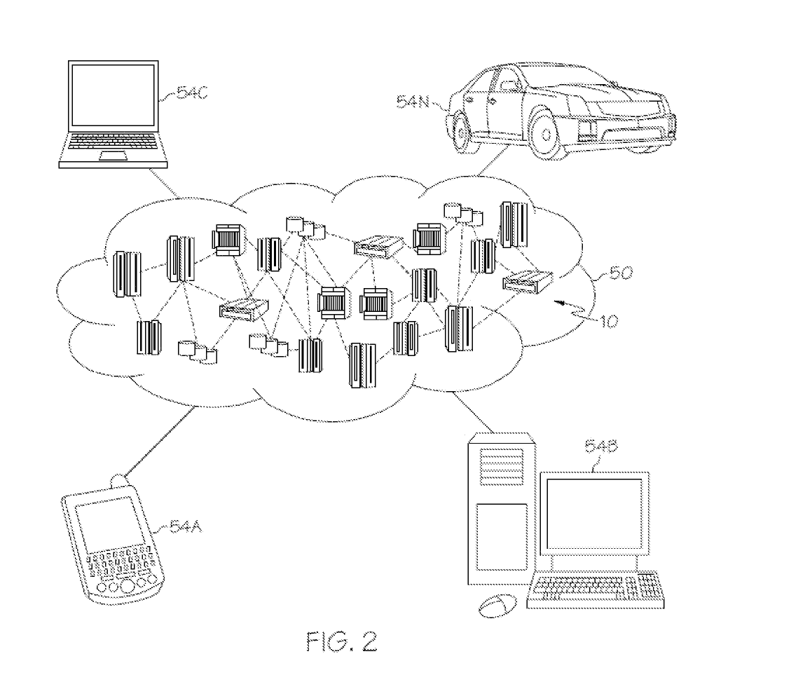

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

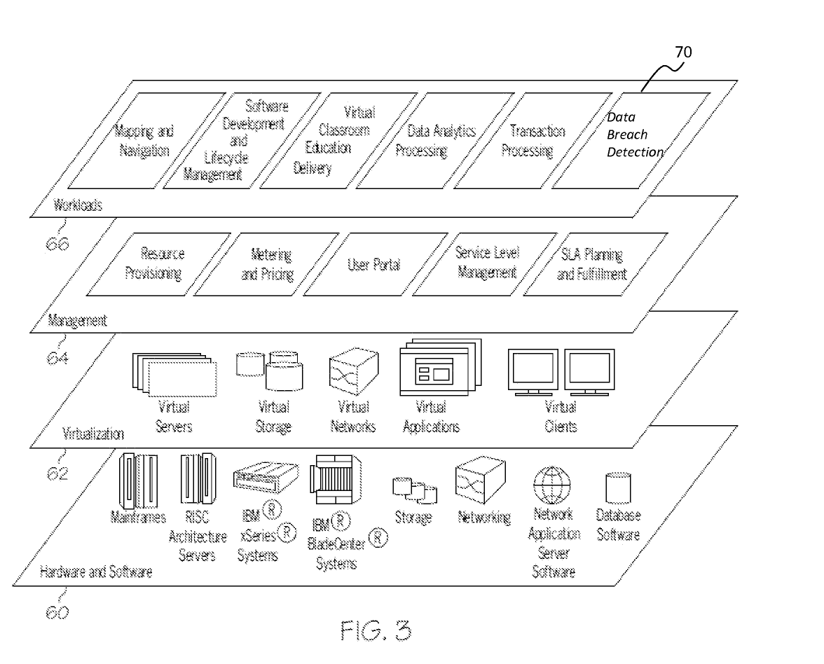

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and data breach detection 70.

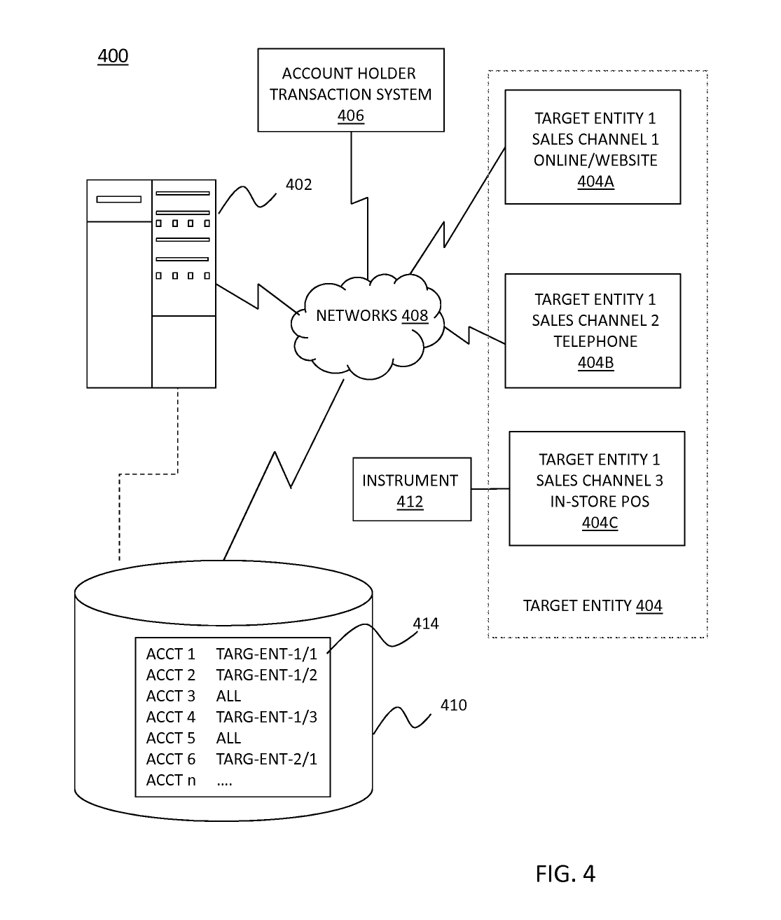

Turning now to FIG. 4, a system 400 upon which the data breach detection processes may be implemented will now be described in an embodiment.

The system 400 includes a host system computer 402, a target entity system 404, and an account holder transaction system (referred to herein as “AHTS”) 406, each of which is communicatively coupled to one or more of networks 408.

The host system computer 402 may be implemented as a high-speed computer processing device for handling the volume of activities associated with users of the data breach detection processes. In an embodiment, the host system computer 402 is operated by a financial institution, such as a bank or lender enterprise. The financial institution may provide financial services to its customers, such as debit/credit cards, loans, investment products, etc. In addition, the financial institution may provide the data breach detection services for designated target entities, such as target entity system 404.

The target entity system 404 may be operated by any entity that offers goods and/or services to customers. For example, the target entity system 404 may be implemented by a retail establishment that offers goods and/or services to customers through one or more sales channels. As shown in FIG. 4, by way of non-limiting illustration, the target entity system 404 includes three different sales channels through which it offers its goods and/or services: sales channel 1 (404A) reflects an online sales channel (e.g., through a website of the target entity), sales channel 2 (404B) reflects a telephone system through which customers may call in to engage in transactions by telephone, and sales channel 3 (404C) reflects a brick-and-mortar facility through which customers may engage in in-person transactions with a target entity representative. The target entity system's 404 sales channels 404A, 404B, and 404C may be supported by various computer processors, analog-based plain ordinary telephone service (POTS) systems, cellular communications systems, and Voice over IP (VoIP) systems, to name a few.

The AHTS 406 represents a device or system through which a transaction with the target entity system 404 is implemented in one embodiment. For example, the AHTS 406 may be a computer, cell phone, or POTS phone. In an embodiment, the host system 402 activates a single use tracking account for a selected individual or entity. This individual or entity is a trusted agent of the host system 402 who is tasked with initiating a transaction with the target entity system 404, which transaction is then tracked by the host system 402. In this embodiment, the individual or entity may be an actual customer (e.g., a banking customer) of the host system 402. The AHTS 406 may initiate a transaction with the target entity system 404 through one of its sales channels 404A, 404B, or 404C, as instructed by the host system 402.

The system 400 of FIG. 4 also includes a storage device 410 communicatively coupled to the host system computer 402. The storage device 410 may be implemented using a variety of devices for storing electronic information. It is understood that the storage device 410 may be implemented using memory contained in the host system computer 402 or it may be a separate physical device, as illustrated in FIG. 4. The storage device 410 may be logically addressable as a consolidated data source across a distributed environment that includes the network(s) 408. Information stored in the storage device 410 is retrieved and manipulated via the host system computer 402.

The storage device 410 houses customer accounts, e.g., in a database 414. The customer accounts (also referred to as “account records”) store account information, such as account number, name of account holder, and expiration date of account. Optionally, the account information may also include account holder address, CCV value, and account balance information. The account information is configured to pass any credit/visual/algorithmic inspection (e.g., the information would comply with LUHN Algorithm).

In an embodiment, customer account records are distinguishable from single use tracking accounts in the storage device 410. For example, single use tracking accounts are each mapped to a target entity identifier. In addition, each single use tracking account may be mapped to a particular sales channel of the target entity. The mapping results in the designation of a particular sales channel to a given single use tracking account (i.e., a designated sales channel). As shown, for example, in FIG. 4, database 414 stores accounts 1-n (ACCTs). TARG-ENT-1/1 refers to a first sales channel of a first target entity, while TARG-ENT-2/1 refers to a first sales channel of a second target entity, whereby the first target entity and the second target entity are independent from and unrelated to each other. Where an account is mapped to “ALL,” this indicates that the account is not a single use tracking account and may be used by a customer without restriction. In other words, the accounts mapped to “ALL” are general-purpose accounts offered by the financial institution for its customers. In this manner, the database 414 shows that the single use tracking accounts may be intermingled with the general population of customer accounts that are not designated as single use. It will be understood that other mechanisms for distinguishing tracking accounts from non-tracking, or general-purpose, accounts may be employed and that the mechanisms described herein are provided for illustrative purposes and are not to be interpreted as limiting in scope.

The account information may be embedded on a physical medium, such as instrument 412 shown in FIG. 4. Alternatively, the account information may be recorded and stored on an electronic device, e.g., in memory of the AHTS 406.

The networks 408 may be any type of known digital communications networks including, but not limited to, a wide area network (WAN), a local area network (LAN), a global network (e.g. Internet), and an intranet. The network(s) 408 include analog-based communication networks (e.g., POTS). In an embodiment, the networks 408 may be implemented to include wireless networking technologies or any kind of physical network implementation known in the art.

In an exemplary embodiment, the host system computer 402 executes an application for implementing the data breach detection processes described herein. For example, the host system 402 may execute the data breach application 70 described in FIG. 3.

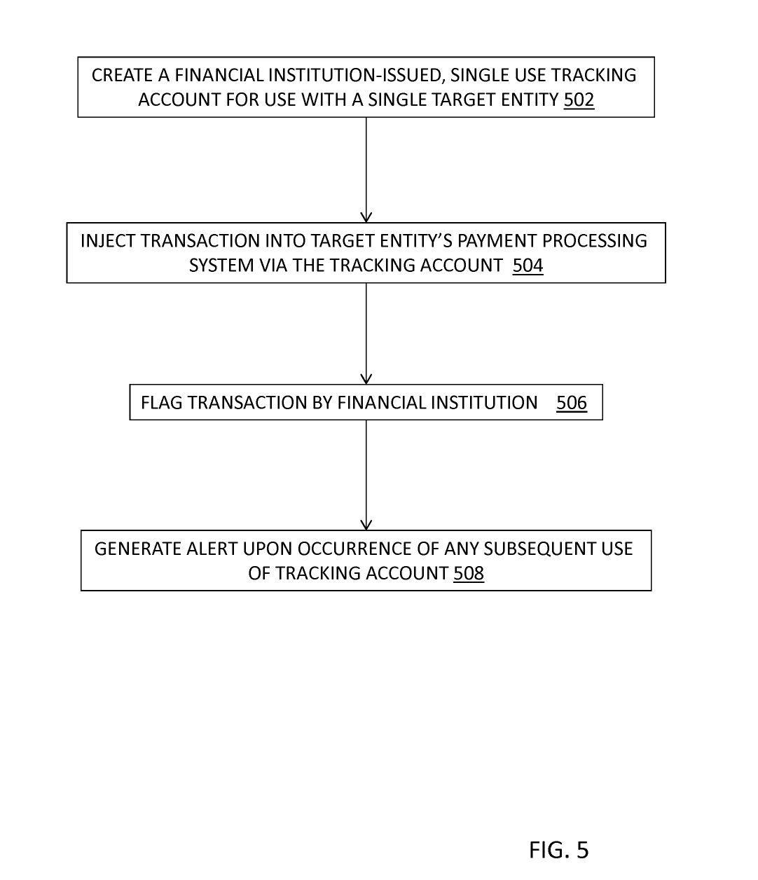

Turning now to FIG. 5, a high-level process flow is described for implementing data breach detection processes. At block 502, the host system 402 creates a single use tracking account configured for use with a single target entity. As indicated above, the single use tracking account is stored in storage device 410 and is mapped to a particular target entity identifier. The single use tracking account includes account information, such as account number, account holder name, and expiration date of account. In an embodiment, the single use tracking account is also mapped to a particular sales channel offered by the target entity, e.g., via a channel identifier.

At block 504, the host system 402 (or the AHTS 406) injects a transaction into the target entity payment processing system (one of the sales channels 404A, 404B, or 404C). At block 506, the host system 402 receives confirmation of the transaction from the target entity system 404 and flags the account record stored at the financial institution to indicate that the single use tracking account has been used. This flag may be any type of marker (e.g., setting a predefined bit in a record string). If any subsequent use (e.g., a purchase or even an account inquiry) of the single use tracking account is attempted, e.g., at the same target entity or at any other target entity, the host system 402 generates an alert at block 508. This subsequent use may indicate that the target entity's payment network has been compromised. For example, if the tracking account is configured for a single use at Target entity 1, sales channel 1, and the financial institution determines that a subsequent use has occurred, the financial institution may fairly determine that the compromise is traceable back to the sales channel 1 of Target entity 1. The alert may be distributed to the target entity, the account holder, a government agency, and/or to any relevant departments or entities associated with the host system 402. In an embodiment, the alert includes the identification of the sales channel that was allegedly compromised.

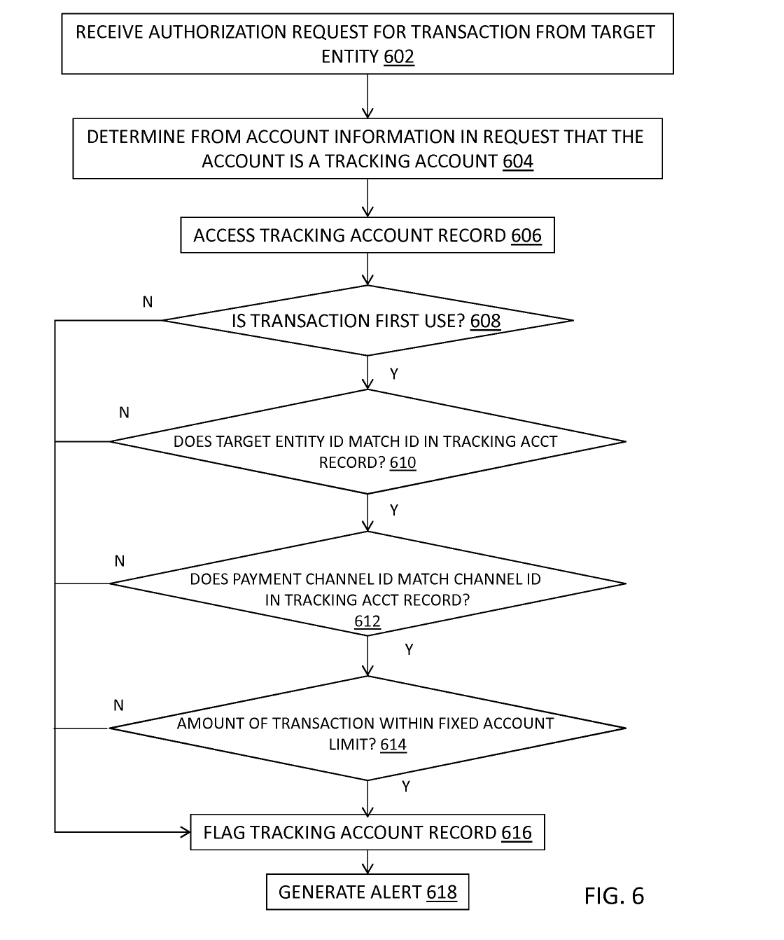

Turning now to FIG. 6, a more detailed process for implementing the data breach detection will now be described in an embodiment. The process described in FIG. 6 assumes that a single use tracking account has been created and that a transaction has been initiated for the single use tracking account with a target entity.

At block 602, the host system 402 receives an authorization request regarding the transaction from the target entity. The authorization request may include identification of the target entity, the account information of the single use tracking account, and an amount of the transaction, if applicable.

At block 604, the host system 402 determines from the account information that the account is a single use tracking account. As indicated above, the account records stored in the storage device 410 provide a mapping between account numbers and target entities if they are created as single use tracking accounts.

At block 606, the host system 402 accesses the account record for the single use tracking account and checks the account to see if the flag has been set. At block 608, if the host system 402 determines from the flag that the transaction is a first use of the single use tracking account, the host system 402 then checks the mapping to make sure that the target entity identifier in the authorization request matches the target entity identifier in the account record at block 610. If so, at block 612, the host system 402 checks to see if the sales channel of the target entity matches the sales channel identifier in the account record. If so, at block 614, the host system 402 may optionally check to see if the amount of the transaction is within the fixed value appropriated by the host system 402 for the single use tracking account. If the amount is within the fixed account limit, the account record flag is set to indicate the first use of the single use tracking account at block 616. The host system 402 may send an alert to a designated entity at block 618. If the responses to any of blocks 608-614 are negative, the host system 402 flags the account record at block 616 and generates an alert at block 618.

The data breach detection can be offered as a service to various entities, such as merchants to provide an additional layer of security for its customers. The service may be offered at various levels of transaction injections (e.g., based on the volume of transactions or number of customers associated with a target entity).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
creating, by a computer processor of a financial institution, a single use tracking account;
mapping the single use tracking account to a single target entity in an account record stored by the financial institution;
processing an initial transaction resulting from utilization of the mapped single use tracking account with the target entity; and
generating an alert upon determining any subsequent use of the single use tracking account.

2. The method of claim 1, wherein the processing includes:
receiving an authorization request from the target entity to implement a transaction with respect to the single use tracking account;
determining whether the transaction is a first use of the single use tracking account, the first use signifying the initial transaction; and
upon determining the transaction is the first use of the single use tracking account, flagging the account record to indicate the first use and sending authorization to the target entity for the initial transaction.

3. The method of claim 1, wherein the processing includes:
receiving an authorization request from the target entity to implement a transaction with respect to the single use tracking account;
determining whether the transaction is a first use of the single use tracking account, the first use signifying the initial transaction; and
upon determining the transaction is not the first use of the single use tracking account, flagging the account record to indicate the subsequent use.

4. The method of claim 1, wherein the processing includes:
receiving an authorization request, from the target entity or from an entity that is not mapped to the single use tracking account in the account record, to implement a transaction with respect to the single use tracking account;
upon determining that the transaction is not the first use of the single use tracking account with respect to the target entity or that the authorization request is from the entity that is not mapped to the single use tracking account in the account record, flagging the account record indicating the subsequent use.

5. The method of claim 1, further comprising mapping the single use tracking account to a designated sales channel of the target entity, wherein the processing includes:
receiving an authorization request from the target entity to implement a transaction with respect to the single use tracking account;
determining whether the transaction is a first use of the single use tracking account, the first use signifying the initial transaction;
determining whether the authorization request originates from the designated sales channel of the target entity; and
upon determining the transaction is the first use of the single use tracking account and the authorization request originated from the designated sales channel of the target entity, flagging the account record and sending authorization to the target entity for the initial transaction.

6. The method of claim 1, further comprising mapping the single use tracking account to a designated sales channel of the target entity in the account record, wherein the processing includes:
receiving an authorization request from the target entity to implement a transaction with respect to the single use tracking account;
determining whether the transaction is a first use of the single use tracking account, the first use signifying the initial transaction;
determining whether the authorization request originates from the designated single sales channel of the target entity; and
upon determining that the transaction is not a first use of the single use tracking account or that the authorization request originated from a sales channel of the target entity that is different than the designated sales channel, flagging the account record and sending the alert.

7. The method of claim 1, wherein the tracking account includes an account number, an account holder name, and an expiration date of the tracking account.

8. A system, comprising:
a memory having computer readable instructions; and
a processor for executing the computer readable instructions, the computer readable instructions including:
creating a single use tracking account for an account holder of a financial institution;
mapping the single use tracking account to a single target entity in an account record stored by the financial institution in the memory;
processing an initial transaction resulting from utilization of the mapped single use tracking account with the target entity; and
generating an alert upon determining any subsequent use of the single use tracking account.

9. The system of claim 8, wherein the processing includes:
receiving an authorization request from the target entity to implement a transaction with respect to the single use tracking account;
determining whether the transaction is a first use of the single use tracking account, the first use signifying the initial transaction; and
upon determining the transaction is the first use of the single use tracking account, flagging the account record to indicate the first use and sending authorization to the target entity for the initial transaction.

10. The system of claim 8, wherein the processing includes:
receiving an authorization request from the target entity to implement a transaction with respect to the single use tracking account;
determining whether the transaction is a first use of the single use tracking account, the first use signifying the initial transaction; and
upon determining the transaction is not the first use of the single use tracking account, flagging the account record to indicate the subsequent use.

11. The system of claim 8, wherein the processing includes:
receiving an authorization request, from the target entity or from an entity that is not mapped to the single use tracking account in the account record, to implement a transaction with respect to the single use tracking account;
upon determining that the transaction is not the first use of the single use tracking account with respect to the target entity or that the authorization request is from the entity that is not mapped to the single use tracking account in the account record, flagging the account record indicating the subsequent use.

12. The system of claim 8, wherein the computer readable instructions further comprise mapping the single use tracking account to a designated sales channel of the target entity, wherein the processing includes:
receiving an authorization request from the target entity to implement a transaction with respect to the single use tracking account;
determining whether the transaction is a first use of the single use tracking account, the first use signifying the initial transaction;
determining whether the authorization request originates from the designated sales channel of the target entity; and
upon determining the transaction is the first use of the single use tracking account and the authorization request originated from the designated sales channel of the target entity, flagging the account record and sending authorization to the target entity for the initial transaction.

13. The system of claim 8, wherein the computer readable instructions further comprise mapping the single use tracking account to a designated sales channel of the target entity in the account record, wherein the processing includes:
receiving an authorization request from the target entity to implement a transaction with respect to the single use tracking account;
determining whether the transaction is a first use of the single use tracking account, the first use signifying the initial transaction;
determining whether the authorization request originates from the designated sales channel of the target entity; and
upon determining that the transaction is not a first use of the single use tracking account or that the authorization request originated from a sales channel of the target entity that is different than the designated sales channel, flagging the account record and sending the alert.

14. The system of claim 8, wherein the tracking account includes an account number, an account holder name, and an expiration date of the tracking account.

15. A computer program product comprising a computer readable storage medium having program instructions embodied therewith, wherein the computer readable storage medium is not a transitory signal per se, the program instructions executable by a computer processor of a financial institution to cause the computer processor to perform a method comprising:
creating a single use tracking account;
mapping the single use tracking account to a single target entity in an account record stored by the financial institution;
processing an initial transaction resulting from utilization of the mapped single use tracking account with the target entity; and
generating an alert upon determining any subsequent use of the single use tracking account.

16. The computer program product of claim 15, wherein the processing includes:
receiving an authorization request from the target entity to implement a transaction with respect to the single use tracking account;
determining whether the transaction is a first use of the single use tracking account, the first use signifying the initial transaction; and
upon determining the transaction is the first use of the single use tracking account, flagging the account record to indicate the first use, and sending authorization to the target entity for the initial transaction.

17. The computer program product of claim 15, wherein the processing includes:
receiving an authorization request from the target entity to implement a transaction with respect to the single use tracking account;
determining whether the transaction is a first use of the single use tracking account, the first use signifying the initial transaction; and
upon determining the transaction is not the first use of the single use tracking account, flagging the account record to indicate the subsequent use.

18. The computer program product of claim 15, wherein the processing includes:
receiving an authorization request, from the target entity or from an entity that is not mapped to the single use tracking account in the account record, to implement a transaction with respect to the single use tracking account;
upon determining that the transaction is not the first use of the single use tracking account with respect to the target entity or that the authorization request is from the entity that is not mapped to the single use tracking account in the account record, flagging the account record indicating the subsequent use.

19. The computer program product of claim 15, wherein the program instructions are further executable to map the single use tracking account to a designated sales channel of the target entity, wherein the processing includes:
receiving an authorization request from the target entity to implement a transaction with respect to the single use tracking account;
determining whether the transaction is a first use of the single use tracking account, the first use signifying the initial transaction;
determining whether the authorization request originates from the designated sales channel of the target entity; and
upon determining the transaction is the first use of the single use tracking account and the authorization request originated from the designated sales channel of the target entity, flagging the account record and sending authorization to the target entity for the initial transaction.

20. The computer program product of claim 15, wherein the program instructions are further executable to map the single use tracking account to a designated sales channel of the target entity in the account record, wherein the processing includes:
receiving an authorization request from the target entity to implement a transaction with respect to the single use tracking account;
determining whether the transaction is a first use of the single use tracking account, the first use signifying the initial transaction;
determining whether the authorization request originates from the designated sales channel of the target entity; and
upon determining that the transaction is not a first use of the single use tracking account or that the authorization request originated from a sales channel of the target entity that is different than the designated sales channel, flagging the account record and sending the alert.
